(19) United States
(12) Patent Application Publication
(10) Pub. No.: US 2008/0152902 A1
(43) Pub. Date: Jun. 26, 2008

(54) Wall Coverings

(75) Inventor: Patricia Adler, London (GB)

Correspondence Address: SUGHRUE MION, PLLC, 2100 PENNSYLVANIA AVENUE, N.W., SUITE 800, WASHINGTON, DC, 20037, US

(73) Assignee: PEPPER-MINT (UK) LIMITED, London (GB)

(21) Appl. No.: 11/910,360

(22) PCT Filed: Mar. 31, 2006
(86) PCT No.: PCT/GB2006/001158

§ 371 Date: Nov. 13, 2007

(30) Foreign Application Priority Data
Mar. 31, 2005 (GB) 0506520.6
Sep. 16, 2005 (GB) 0518955.0

(51) Int. Cl. B32B 5/16; B05D 5/12; B65D 71/00; B44C 7/00

(52) U.S. Cl. 428/329; 427/130; 156/71; 206/575

(57) ABSTRACT

A method of producing a wall covering comprising the steps of (a) rendering a wallpaper substrate magnetically receptive by coating a wallpaper substrate with a composition comprising magnetically receptive iron oxide pigments and over-printing the wallpaper substrate. A wall covering with a magnetically receptive coating and a kit comprising such wall covering in combination with a magnet are further described.

The present invention relates to a magnetically receptive wall covering and a kit comprising such a covering in combination with at least one magnet.

For many years, wall coverings, commonly referred to as wallpapers, have been used to decorate the walls of one's home and work space. Such wallpaper normally features a static, repeating decorative design which is generally printed or embossed on to a base substrate. The wallpaper is then adhered to the wall to be covered by means of an adhesive applied to the non-decorated side of the wallpaper.

The problem with currently available wallpaper is that it is, by its nature, static. The user decides upon a design which then remains the same for the duration of the time that the wallpaper is displayed. Thus if the user wishes to change the design, the wallpaper must be removed and replaced by an alternative wallpaper. This is both time consuming and expensive.

In light of this, the current trend has been for interactive wallpaper whereby the user can customise the wallpaper either by use of stickers or by colouring portions of the wallpaper. Again, however, while this offers the advantage of personalising the paper, the problem still remains that the design decided upon remains fixed. It is therefore clear that there is a need for a wall covering which not only offers the consumer the opportunity to personalise it, but also allows the design to be changed as and when the consumer desires.

In this regard, the present applicant has focussed on the provision of a magnetically receptive wallpaper which enables the user to adhere magnets onto the wallpaper including decorative or symbolic magnetic motifs. The use of a magnetic paint to render a substrate such as a film or even a wall magnetically receptive has been done in the past. For example, WO-A-00/01776 describes a coating containing ferromagnetic particles, in particular iron oxide, which can be spread evenly on a surface such as cardboard.

A problem with magnetic paint to be applied directly to walls is that it often requires up to four coats in order to achieve the required magnetic receptivity. Furthermore, while various magnetic paints are available, it will be appreciated that it is not as simple as just applying these to a standard wallpaper. There are various other considerations which come into play such as the weight of the coating, ensuring that an even distribution of magnetic receptivity is achieved and the capability of the coating to be overprinted to produce a desirable end colour and/or decorative image.

A problem exists in the application of magnetically receptive coatings to substrates. The metallic pigments in the coating compositions are by definition heavy which mean that have a tendency to sink to the bottom of any composition. This tendency can be reduced by increasing the viscosity of the coating. However, then problems are encountered in applying such viscous coating compositions. Developing a coating which can be applied by conventional machinery at a rate which is economically viable has proved problematic. There is thus a need for a magnetically receptive coating which can be applied by conventional means at a reasonable rate.

A further problem encountered is in the overprinting of magnetically receptive coatings. Such coatings tend to have a dark grey or black colour which is generally not a colour which is favoured by the wallpaper industry. It is therefore desirable to be able to print a different colour over the top of such coatings. However passing a substrate coated with currently available magnetic paints through a printing machine which is worth a large amount of money is considered to be unacceptable at the present time as it is known that the magnetic pigments damage the printing machines due to having unacceptable coarse surfaces.

In solving these problems, the present invention provides a method of producing a wall covering comprising the steps of:

(a) transferring a wallpaper substrate to a coating apparatus;

(b) coating a surface to be displayed of the wallpaper substrate with a coating composition comprising a magnetically receptive iron oxide pigment, a diluent and a binder wherein at least 90% of the magnetically receptive iron oxide pigment has a particle size of less than 50 μm; and

(c) solidifying the coating composition to form a magnetically receptive coating on the wallpaper substrate wherein the dry coat weight of the total magnetically receptive coating is greater than 30 gm⁻² and less than 200 gm⁻².

The present invention further provides a wall covering coated on a side to be displayed, with a magnetically receptive coating comprising a magnetically receptive iron oxide pigment and a binder wherein at least 90% of the magnetically receptive iron oxide pigment has a particle size of less than 50 μm; and the dry coat weight of the total magnetically receptive coating is greater than 30 gm⁻² and less than 200 gm⁻².

A further aspect of the present invention is a kit which contains the wall covering described above in combination with at least one magnet which is preferably a decorative magnet.

The invention further relates to a method of decorating a wall wherein the wall covering described is adhered to a wall by use of an adhesive.

As detailed above, the present invention provides a method wherein a wallpaper substrate is coated. The wallpaper substrate may be any wallpaper base which is commercially available and as such may be natural or synthetic based. Examples of suitable commercially available wallpaper substrates include both paper and fabric backed substrates. Preferably the wallpaper base has a weight of at least 100 gm⁻², more preferably at least 130 gm⁻² and most preferably, at least 150 gm⁻². A particularly preferred wallpaper substrate for use in the method of the present invention is a non woven wallpaper base with a weight of 147 gm⁻². Suitable wallpaper substrates are commercially available from, for example, Ahlstrom, UK.

In a further embodiment, the wallpaper substrate may comprise a backing layer of paper to which a vinyl top layer has been laminated.

In a particularly preferred embodiment, at least 90% of the magnetic pigment has a particle size of less than 20 μm.

The wallpaper substrate is coated with a coating which renders it magnetically receptive. The coating in question comprises, as one component, a magnetically receptive iron oxide pigment. In order to obtain a coating which imparts the required degree of magnetic receptivity, the Applicant has found that the size distribution of the iron oxide pigment is a crucial consideration. More specifically, it has been found that at least 90% of the magnetic pigment should have a particle size of less than 50 μm. More preferably, at least 90% of the magnetic pigment should have a particle size of less than 35 μm. In a preferred embodiment of the present invention, preferably the median particle size (50% value) is in the range of at least from 2 to 25 μm. More preferably, 50% of the particles have a particle size of less than about 15 μm. In a particular preferred embodiment, 50% of the particles have a particle size of less than about 5 μm.

Preferably iron oxide is the major component of the magnetic pigments. Preferably the iron oxide is magnetite (Fe₃O₄). Magnetite is a magnetic mineral form of both iron(II) oxide and iron(III) oxide or (iron(II,III) oxide).

The skilled person will appreciate that the pigment may also contain small amounts of impurities such as phosphorus, silicon dioxide and sulphur.

Preferably in one embodiment of the present invention, magnetically receptive the pigments are spherical. In a further embodiment of the present invention, the magnetically receptive pigments may be potato shaped. Preferably the magnetically receptive pigments have a smooth surface.

By selecting magnetically receptive pigments which satisfy these criteria, it is further ensured that when suspended in the coating composition, the magnetically receptive pigments remain suspended for a sufficiently long period of time to enable the wallpaper to be coated. Furthermore, if the magnetically receptive pigment does not settle, it can be easily resuspended. An example of suitable magnetically receptive iron oxide particles which are particularly preferred are Electr Oxide 40 pigment and ElectrOxide 20 pigment available commercially from Hoganas, UK. The content of iron oxide pigments in the coating composition is preferably less than 60%, more preferably less than 50% by weight.

The coating composition used in the present invention, further comprises a diluent. The purpose of the diluent is to behave as a liquid vehicle for the other components and it does not form part of the final coating composition once dried. The diluent may be an organic solvent or water. Examples of suitable organic solvents include but are not limited to alcohols, ketones, esters, glycol ethers and low molecular weight synthetic resins. All suitable diluents share the property that they are volatile.

A further essential component of the coating composition is a binder. Binders are generally natural or synthetic resins. Where the diluent is water, the binder may be an emulsion or resin. A particularly preferred binder in this case is a styrene acrylic emulsion stabilised with 0.1% ammonia. An example of such a commercially available binder is Lucidene 606LS available from Morton. Where the diluent used is water optionally the coating composition further includes an anti-foaming agent. If an anti-foaming agent is to be included, it should be used in an amount of less than 0.5% (by weight). If it is included in an amount greater than this, it can cause printing defects at a later stage. An example of a suitable water based coating composition is one containing 49.85% of a water based styrene acrylic copolymer solution, 0.15% of anti-foaming agent and 50% of magnetic pigments. A further example of a suitable water based coating composition is one containing 47.85% of a water based styrene acrylic copolymer solution, 0.15% of anti-foaming agent, 2% of soft water and 50% of magnetic pigments. Where the substrate to which the magnetically receptive coating is applied is a vinyl coated wallpaper substrate, instead of using a styrene-acrylic copolymer, it is advantageous to use an aliphatic urethane dispersion as the binder. An example of such a binder is Neorez R-961 commercially available from Zeneca resins.

Where the diluent is solvent based, examples of suitable binders include mixtures of acrylic and vinyl resins. An example of a suitable solvent based coating is one containing 37.5% of a vinyl resin, 12.5% of solvent and 50% of magnetic pigments. After application, the coating composition solidifies and becomes tack free. The reason for the hardening depends on the nature of the binder. For example, it may be as a result of evaporation, cooling (where the coating composition has been applied at an elevated temperature) or cross-linking (curing).

Preferably the weight ratio of binder to magnetic pigment included in the coating composition is in the range from 3:1 to 1:3. More preferably, the coating composition contains a greater proportion of magnetic pigment than binder i.e. the ratio of binder to magnetic pigment is less than 1:1.

In an alternative embodiment, the magnetically receptive iron oxide pigment may be added to a pre-mixed liquid vinyl composition, known conventionally as a plastisol. In this embodiment, therefore, the coating composition comprises a mixture of plastisol and the magnetically receptive iron oxide pigment.

There are various methods by which the coating composition may be applied to the wallpaper substrate. The coating is preferably applied at a speed in the range of 12 to 45 m/min. Advantageously, rather than requiring a specialised application method, the coating of the present invention may be applied by conventional techniques including brush coating, size press coating, dip coating, rod (or bar) coating, air knife coating, kiss coating, spray coating, blade coating, transfer roll coating, reverse roll coating, cast coating and screen coating. A particularly preferred method for applying the coating composition is by air-knife coating. This is a technique well known in the wallpaper industry which is inexpensive to implement and maintain.

The coating composition is applied to the outer surface of the wallpaper substrate that will ultimately be on display.

The coating composition may be applied so as to render the entire surface of the wallpaper substrate magnetically receptive or alternatively it may be applied over only limited parts of the surface of the wallpaper substrate.

It is of crucial importance that the coated wall covering which results from the method of the present invention has the required magnetic receptivity. As noted above, the purpose of the present invention is to provide a magnetically receptive wall covering to which magnets may be adhered in a non-permanent fashion. Examples of suitable magnets include decorative and symbolic magnets. Further suitable magnets include light duty functional magnets such as CD holders and picture frames.

The degree of magnetic receptivity imparted to the wallpaper thus needs to be sufficient to hold such a decorative magnet in place until the user wishes to change its position. Additionally, the magnetic force between the coated wall covering and a decorative magnet needs to be sufficiently small that the magnets can be removed manually without requiring excessive force. Clearly the balance is important. In the present invention, the magnetic properties of the coating composition are evaluated using a simple test. In this test, a magnet with a weight of approximately 7.85 g, an approximate diameter of 26 mm and a thickness of approximately 0.5 mm is used. The coating composition is applied to the wallpaper substrate by the method described above. After drying and consequent hardening of the coating, the coated wall covering is adhered to a stiff board. The stiff board is then held horizontally with the coated surface facing downwards. The magnet is then applied. If the magnet remains adhered to the board then the sample passes the test. Coatings are repeated until the point is reached where the magnet is held firmly in place but can be removed manually without requiring excessive force. It may be the case that only a single coating is required or alternatively it may be necessary to apply multiple coatings. By carrying out such tests, the Applicant has determined that, in order to achieve the required magnetic properties, the applied dry coat weight of the total magnetically receptive coating must be greater than 30 gm⁻². Additionally, for reasons relating to overprintability, the applied dry coat weight of the total magnetically receptive coating must be less than 200 gm⁻². Preferably the dry coat weight of the total magnetically receptive coating is in the range from 100 to 180 gm⁻², most preferably 145 to 165 gm⁻².

In the preferred embodiment of the present invention, the method includes a further step of overprinting the magnetically receptive coating by transferring the wallpaper substrate to a printing machine where ink is applied over the magnetically receptive coating. In this step, the entire surface of the wallpaper substrate may be overprinted or it may be desirable to overprint an image on to the coated wallpaper. It has surprisingly been found that the coating of the present invention has a sufficiently smooth surface and low levels of migratory active species to enable overprinting to be carried out by means of conventional printing machines. Overprinting may be carried out by various techniques including, for example, screen printing, an air-knife technique (to print a solid colour) and/or a flexographic technique (to print a solid colour and/or design), lithographic printing, gravure printing, digital inkjet and also web offset printing.

In the overprinting step, the ink is applied over the magnetically receptive coating. In this regard, the ink may be applied directly to the magnetically receptive coating or alternatively a layer may be applied over the magnetically receptive coating prior to printing. In a preferred embodiment, the ink is applied decoratively.

In one embodiment, a seal coat may be applied onto the dried coating prior to overprinting. This may be done to avoid scratching, rubbing or scuffing of the dried coating in particular caused by marking from the magnets. The seal coat is generally transparent. The seal coat may or may not contain pigment. A further advantage of the present invention is that, once dried, the coating does not bleed or rub off.

The magnets included in the kit of the present invention may be any sort of magnet. In particular, the magnets may be design motifs, board game motifs or child learning aid motifs. Further examples of suitable magnets include light duty functional magnets such as CD holders and picture frames.

The present invention further relates to a method of decorating a wall comprising the step of adhering the wallpaper of the present invention to a wall by using an adhesive. Having adhered the wallpaper to the wall, at least one magnet may then be applied to the wall which is now magnetically receptive by virtue of the wallpaper adhered thereto.

The adhesive used to adhere the wallpaper to the wall may be any adhesive commonly used in the industry. Examples of suitable adhesives include high quality wallpaper paste available from, for example, Cole & Son, UK.

It may be necessary to either apply the adhesive to the surface of the wallpaper to be in contact with the wall or it may be the case that the surface of the wallpaper to be contacted with the wall has been primed with an adhesive to which it is just necessary to add water to achieve the required tackiness.

The present invention will now be further described by reference to the following figures and examples which are in no way intended to limit the scope claimed.

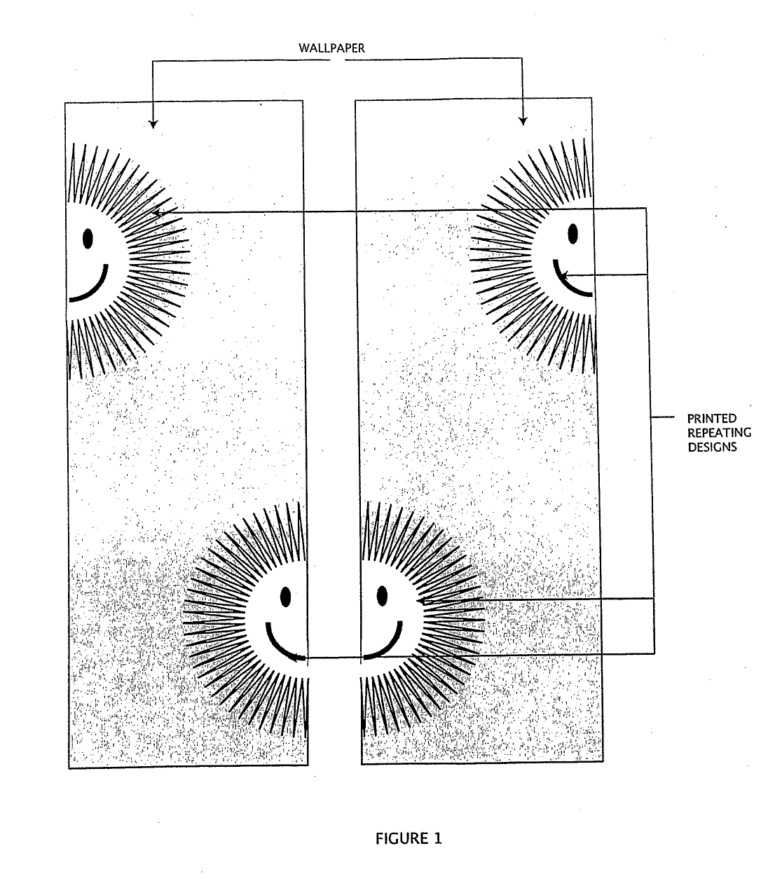

FIG. 1 illustrates an example of traditional wallpaper with a pre-set printed design;

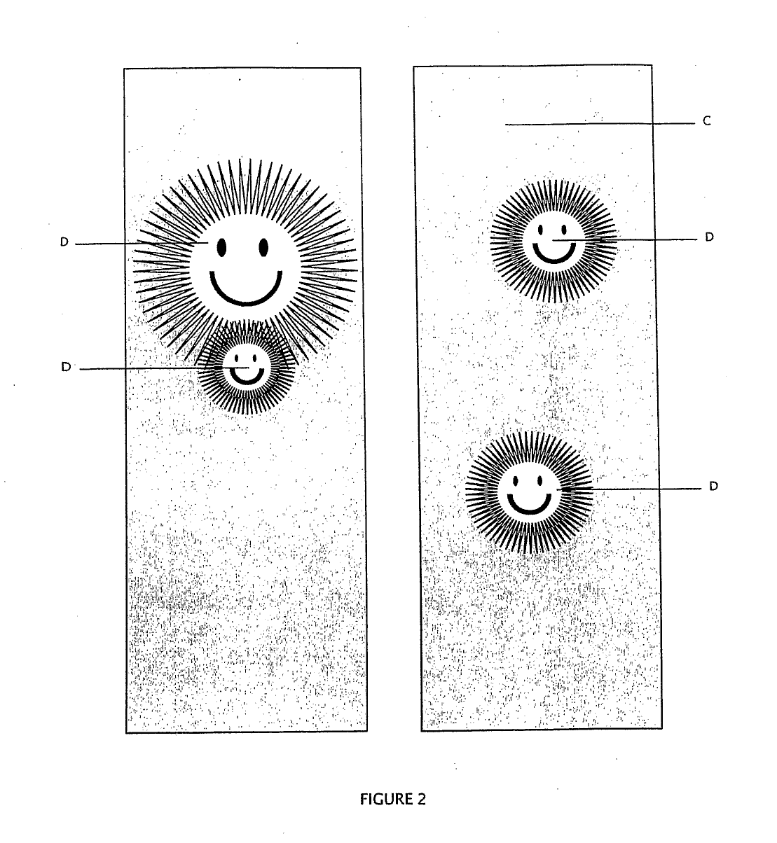

FIG. 2 shows an example of a wallpaper with a magnetically receptive coating according to the present invention;

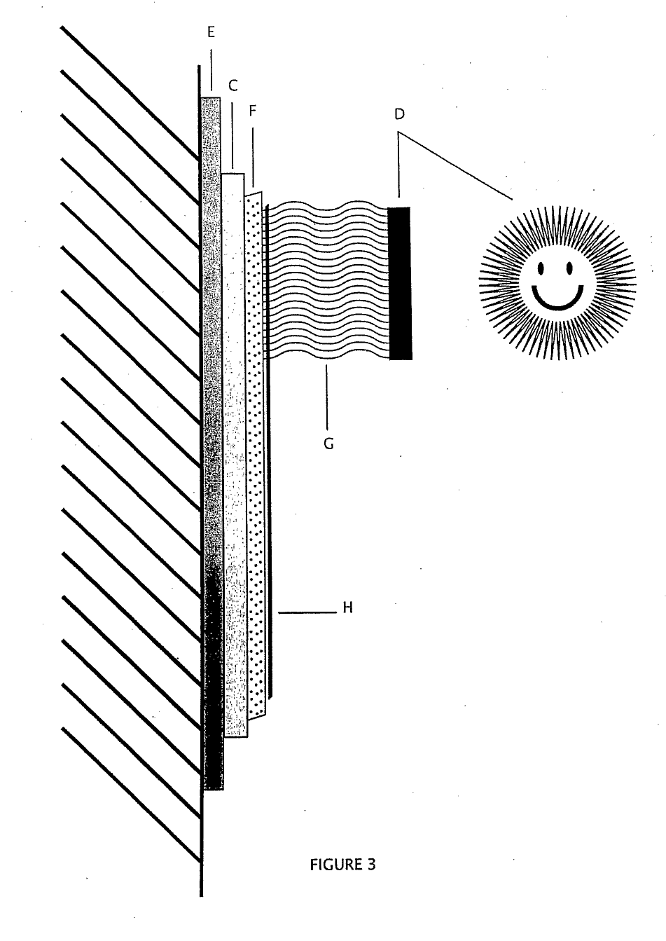

FIG. 3 shows a cross-section through an example of the wallpaper with a magnetically receptive coating according to the present invention wherein the magnetically receptive coating is on the outer side;

FIG. 2 shows a wallpaper with a magnetically receptive coating, for use on walls, panels and the like (C). By using this wallpaper to cover walls, panels and the like, the user is enabled to ‘non-permanently adhere’ a variety of decorative magnetic motifs (D) onto the paper. This enables the user to create personalised designs that remain infinitely re-positionable.

FIG. 3 shows the wallpaper (C) with a magnetically receptive coating (F) wherein the coating comprises a plurality of magnetically receptive iron oxide pigments. The wallpaper is, thus, magnetically receptive (G), enabling the user to ‘non-permanently adhere’ a variety of decorative magnetic motifs (D) onto the paper. Furthermore, the wallpaper with a magnetically receptive coating (C+F) allows for designs to be printed (H) onto its treated surface. The wallpaper is adhered to the wall by means of an adhesive (E)

### EXAMPLES

Coating compositions including several different magnetic pigments were tested to determine their suitability as a magnetic pigment in the coating compositions of the present invention. The coating compositions tested in this example were all solvent based and had the general formulation of:

| | |
|---|---|
| Vinyl medium | 37.5 |
| Solvent | 12.5 |
| Magnetically receptive Pigment | 50.0 |
| as measured by weight % | |

The vinyl medium used was a mixture of toluene, acrylic polymer and copolymer of vinyl chloride and vinyl isobutyl ether.

Five different types of magnetically receptive pigment were tested, specifically, Pigments A to D and Electr Oxide 40, all commercially available from Hoganas UK. The properties of these different magnetically receptive pigments are detailed below.

Pigment A Iron particles
Particle Size: % of particles with size <38 μm=30-55%
   Pigment B Iron particles (superfine)
Particle size: minimum of 80% of particles have size <45 μm
   Pigment C Iron particles (fine)
Particle size: minimum of 25% have particle size <45 μm Pigment D Iron particles
Particle size: maximum of 2% have particle size >150 μm

### Electr Oxide 40 Magnetite

Particle size: At least 90% below 35 μm.

The coating compositions were applied to a non-woven wallpaper base substrate with a weight of 149 gm⁻² which was obtained from Ahlstrom, UK. The test with the magnet which is described above was then carried out in order to assess the properties of the coatings. The results are shown in Table 1 below.

TABLE 1

| | WET COAT | | | | |
|---|---|---|---|---|---|
| | WEIGHT | | | | |
| | REQUIRED | DRY COAT | | | |
| | (@65% | WEIGHT | | | STABILITY |
| MAGNETIC | SOLID) | REQUIRED | | SMOOTH- | (100% |
| PIGMENT | (gsm) | (gsm) | MAGNETISM | NESS | SETTLEMENT) |
| Pigment A | 375 | 241 | ✓ | 4 | 24 hr |
| | 96 μm | | | | |
| Pigment B | 314 | 205 | ✓ | 4 | 24 hr |
| | 96 μm | | | | |
| Pigment C | 423 | 275 | ✓ | 5 | 24 hr |
| | 96 μm | | | | |
| Pigment D | 409 | 266 | ✓ | 3 | 24 hr |
| | 120 μm | | | | |
| ELECTR | 140.6 | 91 | ✓ | 2 | 24 hr |
| OXIDE 40 | 72 μm | | | | |

The smoothness of the final dry coating was measured and the results are shown in the fifth column of Table 1. Smoothness is quantified according to the Sheffield Scale (SS) which can be summarised as follows:

| | |
|---|---|
| 1 = very smooth | (SS rating 50-150) |
| 2 = smooth | (SS rating 150-250) |
| 3 = coarse | (SS rating = 250-350) |
| 4 = rough | (SS rating = 350-450) |
| 5 = very rough | (SS rating = 450-600) |

The stability measurement refers to the length of time which passes before the magnetically receptive pigments settle to the bottom of the coating composition.

The figure quoted in μm in the second column of the table is the maximum recorded particle size for the pigment in question.

The results clearly show that the coating obtained using Electr Oxide 40 magnetic pigments are better as compared to the results obtained using the other magnetic pigments.

### Example 2

As the results obtained from the first example clearly demonstrated the superiority of the coating composition obtained where Electr Oxide 40 was used as the magnetically receptive pigment, a further water-based coating composition was prepared using this pigment.

The coating composition had the following formulation:

| | |
|---|---|
| Water-based carrier | 49.85% |
| (styrene Acrylic emulsion at 46% solids) | |
| stabilised with 0.1% ammonia | |
| Antifoam | 0.15% |
| Magnetically receptive pigment | 50% |
| (Electr Oxide 40) | |

The coating was applied to a non-woven wallpaper base substrate with a weight of 149 gm⁻² which was obtained from Ahlstrom, UK. As described above, the properties of this coating were assessed and the results are shown in Table 2 below:

TABLE 2

| | Wet coat | Dry coat | | | |
|---|---|---|---|---|---|
| | weight | weight | | | |
| Magnetically | @73% | @73% | | | |
| receptive | solid | solid | | Smooth- | |
| pigment | (gsm) | (gsm) | Magnetism | ness | Stability |
| Electroxide | 216 | 158 | ✓ | 2 | 24 hr |
| 40 | 87 μm | | | | |

Again these results demonstrate the advantages of using a coating composition as described in the present invention.

### Example 3

Further experiments were carried out to investigate the effect that reducing the particle size of the magnetically receptive pigment further. All of the coating compositions tested fall within the present invention and have the formulations as shown below:

| | |
|---|---|
| FORMULATION | 47.85 wt % styrene acrylic copolymer |
| A: | (Lucidene 606LS available from Morton) |
| | 2.00 wt % soft water |
| | 0.15 wt % antifoam (Tego Foamex 805) |
| | 50.0 wt % Electr Oxide 20 (magnetite, |
| | particle size: at least 90% below 20 μm) |
| FORMULATION | 49.85 wt % aliphatic urethane dispersion |
| B: | (Neorez R-961 from Zeneca Resins) |
| | 0.15 wt % antifoam agent |
| | 50.00 wt % Electr Oxide 20 |
| FORMULATION | 49.85 wt % styrene acrylic copolymer |
| C: | (Lucidene 606LS from Morton) |
| | 0.15 wt % antifoam agent |
| | 50.0 wt % Electr Oxide 40 (Magnetite, |
| | particle size: at least 90% below 35 μm) |
| FORMULATION | 49.85 wt % aliphatic urethane dispersion |
| D: | (Neorez R-961 from Zeneca Resins) |
| | 0.15 wt % antifoam |
| | 50.0 wt % Electr Oxide 40. |

Formulations A and C were applied to a non-woven wallpaper base substrate with a weight of 149 gm⁻² which was obtained from Ahlstrom, UK.

Formulations B and D were applied to a vinyl substrate grade 91/10 from Speciality Coatings Limitied (SCL)

As described in Example 1, the properties of the coatings were assessed and the results are shown in Table 3.

TABLE 3

| | Wet Coat | Dry Coat | | | |
|---|---|---|---|---|---|
| | Weight | Weight | | | Stability % |
| Formu- | Required | Required | Mag- | Smooth- | Settlement |
| lation | gm⁻² | gm⁻² | netism | ness | 24 hr |
| Formu- | 154 @ | 112 | ✓ | 1 | 30% |
| lation A | 72.5% solid | | | | |
| Formu- | 167 @ | 112 | ✓ | 1 | 30% |
| lation B | 67% solid | | | | |
| Formu- | 153 @ | 112 | ✓ | 2 | 100% |
| lation C | 73% solid | | | | |
| Formu- | 167 @ | 112 | ✓ | 2 | 100% |
| lation D | 67% solid | | | | |

1. A method of producing a magnetically receptive wall covering comprising the steps of:
(a) transferring a wallpaper substrate to a coating apparatus;
(b) coating a side to be displayed of the wallpaper substrate with a coating composition comprising a magnetically receptive iron oxide pigment, a diluent and a binder wherein at least 90% of the magnetically receptive iron oxide pigment has a particle size of less than 50 μm; and
(c) solidifying the coating composition to form a magnetically receptive coating on the wallpaper substrate, wherein the dry coat weight of the total magnetically receptive coating is greater than 30 gm⁻² and less than 200 gm⁻².

2. The method according to claim 1, which includes a further step of:
(d) overprinting the magnetically receptive coating by transferring the wallpaper substrate to a printing machine where ink is applied over the magnetically receptive coating.

3. The method according to claim 1, wherein at least 90% of the magnetically receptive iron oxide pigment has a particle size of less than 35 μm.

4. The method according to claim 1, wherein at least 90% of the magnetically receptive iron oxide pigment has a particle size of less than 20 μm.

5. The method according to claim 1, wherein the median particle size of the magnetically receptive iron oxide pigment is in the range from 10 to 25 μm.

6. The method according to claim 1, wherein the iron oxide pigment is magnetite.

7. The method according claim 1 wherein the wallpaper substrate has a weight of at least 100 gm⁻², more preferably at least 130 gm², most preferably at least 150 gm⁻²

8. The method according to claim 1, wherein the magnetically receptive iron oxide pigments are present in the coating composition in an amount of up to 60% by weight

9. The method according to claim 1, wherein the diluent is water.

10. The method according to claim 9, wherein the binder is a styrene acrylic emulsion.

11. The method according to claim 9, wherein the coating composition further comprises an anti-foaming agent.

12. The method according to claim 1, wherein the diluent is an organic solvent.

13. The method according to claim 12, wherein the organic solvent is toluene.

14. The method according to claim 11, wherein the binder is a mixture of acrylic and vinyl resins.

15. The method according to claim 1, wherein the coating composition comprises a liquid vinyl and the magnetically receptive iron oxide pigment.

16. The method according to claim 1, wherein the coating composition is applied to the wallpaper substrate by the coating apparatus using a technique selected from brush coating, size press coating, dip coating, rod (or bar) coating, kiss coating, spray coating, blade coating, transfer roll coating, reverse roll coating, cast coating, screen coating and air knife printing.

17. The method according to claim 2, wherein a step of applying a seal coat is included prior to the overprinting step.

18. The method according to claim 1 wherein the wallpaper substrate comprises a paper backing layer to which a vinyl layer has been adhered.

19. A wallpaper coated on a side to be displayed with a magnetically receptive coating comprising a magnetically receptive iron oxide pigment and a binder wherein at least 90% of the magnetically receptive iron oxide pigment has a particle size of less than 50 μm; and
the dry coat weight of the total magnetically receptive coating is greater than 30 gm⁻² and less than 200 gm⁻².

20. The wallpaper according to claim 19, wherein a seal coat is applied over the magnetically receptive coating.

21. The wallpaper according to claim 19, wherein the magnetically receptive coating is overprinted with a solid colour.

22. The wallpaper according to claim 19, wherein the magnetically receptive coating is overprinted with a decorative image.

23. A method of decorating a wall comprising the step of adhering the wallpaper of claim 19 or the wallpaper produced by the method according to claim 1, to a wall by using an adhesive.

24. The method according to claim 23 which comprises the further step of non-permanently adhering at least one decorative magnet to the wallpaper.

25. The method according to claim 19, wherein the adhesive is a wallpaper paste.

26. A kit comprising the wallpaper of claim 19 and at least one magnet.

27. The kit according to claim 26, wherein the at least one magnet is a decorative magnet.
